(19) United States
(12) Patent Application Publication
(10) Pub. No.: US 2006/0015752 A1
(43) Pub. Date: Jan. 19, 2006

(54) Memory having RFID tag, decryption technique for use with the memory, and memory reader or writer for use with the memory

(75) Inventor: Steven T. Krueger, Deerfield, WI (US)

Correspondence Address: FITZPATRICK CELLA HARPER & SCINTO, 30 ROCKEFELLER PLAZA, NEW YORK, NY, 10112, US

(73) Assignee: Promega Corporation, Madison, WI (US)

(21) Appl. No.: 10/892,158

(22) Filed: Jul. 16, 2004

(51) Int. Cl. G06F 12/14

(52) U.S. Cl. 713/193

(57) ABSTRACT

A system comprising a memory, an RFID tag, a memory reading unit that is configured to read information that is stored by the memory, an RFID reading unit that is configured to read information that is stored by the RFID tag, and a decryption unit that is configured to decrypt the information read from the memory by the memory reading unit in accordance with the information read from the RFID tag by the RFID reading unit.

### FIELD OF THE INVENTION

The present invention relates to a memory having a Radio Frequency Identification (RFID) tag, a decryption technique for use with the memory, and a memory reader and/or writer for use with the memory.

### BACKGROUND OF THE INVENTION

RFID is a technique in which an RFID reader (also known as an RFID interrogator or RFID scanner or RFID detection device) obtains information stored in an RFID tag. RFID tags generally include an antenna and an RFID chip. Typically, the RFID reader emits a radiofrequency signal. The RFID tag receives the signal. One type of RFID tag, known as a passive tag, uses the signal as a source of energy to power the RFID tag. Another type of RFID tag, known as an active tag, contains its own energy source. In either case, the RFID chip, typically a circuit including a memory, modulates a response to the signal, which response is detected by the RFID reader. Typically, the RFID chip uses this technique to send, as the response, an identification code stored in the memory back to the RFID reader, which code can be used, for example, for inventory purposes.

Several documents discuss RFID use in the computer or memory medium fields. For example, U.S. Pat. No. 5,949,335 (Maynard) discloses an RFID tagging system for computer network assets, wherein operation of the asset can be automatically inhibited absent completion of a predetermined communications sequence between the asset and an RFID host. U.S. Pat. No. 6,424,262 B2 (Garber, et al.) discloses use of RFID, wherein the item may be, for example, a magnetic or optical medium. And PCT WO 03/073225 A2 (Kollar, et al.) discloses an RFID tag attached to an article, wherein the article may be, for example, a CD, DVD, memory stick, CompactFlash card, and Secure Digital card.

### SUMMARY OF THE INVENTION

In view of the foregoing, in one aspect, the present invention relates to supplying a memory medium (e.g., CD, DVD, Memory Stick, flash memory, etc.) with an RFID tag. The RFID tag could be attached to the memory medium. For example, the memory medium could be a CD, and the RFID tag could comprise an RFID antenna and an RFID chip, wherein the RFID antenna could be printed on the CD, and then the RFID chip attached to the antenna. The RFID tag could be used for inventory purposes, in conjunction with a RFID detection device. Also, a memory reader (e.g., CD drive, DVD drive, Memory Stick reader, flash memory reader, etc.) could also be equipped with a RFID detection device. The memory reader could then determine whether or not to read the memory medium in accordance with the RFID detection. And, optionally, the memory reader could perform decryption in accordance with the RFID detection.

In another aspect the present invention relates to a system comprising (a) a memory; (b) an RFID tag; (c) a memory reading unit that is configured to read information that is stored by the memory; (d) an RFID reading unit that is configured to read information that is stored by the RFID tag; and (e) a decryption unit that is configured to decrypt the information read from the memory by the memory reading unit in accordance with the information read from the RFID tag by the RFID reading unit.

In yet another aspect, the present invention relates to an apparatus comprising (a) a memory reading unit that is configured to read information that is stored by a memory; (b) an RFID reading unit that is configured to read information that is stored by an RFID tag; and (c) a decryption unit that is configured to decrypt the information read from the memory by the memory reading unit in accordance with the information read from the RFID tag by the RFID reading unit.

In still another aspect, the present invention relates to a apparatus comprising (a) memory reading means for reading information that is stored by a memory; (b) RFID reading means for reading information that is stored by an RFID tag; and (c) decryption means for decrypting the information read from the memory by the memory reading means in accordance with the information read from the RFID tag by the RFID reading means.

In a still further aspect, the present invention relates to a method comprising (a) retrieving information from a memory; (b) retrieving information from an RFID tag; and (c) decrypting the information retrieved from the memory in accordance with the information retrieved from the RFID tag.

In yet another aspect, the present invention relates to a system comprising (a) a memory; (b) an RFID tag attached to the memory; (c) an encryption unit that is configured to encrypt information so that the encrypted information can later be decrypted, the decryption being performed in accordance with information obtained from the RFID tag; and (d) a writing unit that is configured to write information to the memory for storage, wherein the encrypted information from the encryption unit is written by the writing unit to the memory for storage.

In a still further aspect, the present invention relates to an apparatus comprising (a) encryption means for encrypting information so that the encrypted information can be decrypted, the decryption being performed in accordance with information retrieved from an RFID tag attached to a memory; and (b) writing means for writing the encrypted information to the memory for storage.

In yet another aspect, the present invention relates to a method comprising (a) writing first information to an RFID tag for storage, the RFID tag being associated with a memory; (b) encrypting second information so that the encrypted second information can later be decrypted, the decryption being performed in accordance with the first information; and (c) writing the encrypted second information to the memory for storage.

In yet a still further aspect, the present invention relates to an apparatus for use with a television, the apparatus comprising (a) an optical disc drive that is configured to perform one of (i) reading from an optical disc and (ii) reading from and writing to an optical disc; (b) an RFID interrogator that is configured to obtain information from an RFID tag associated with the optical disc; (c) a decryption unit that is configured to decrypt information read from the optical disc by the optical disc drive in accordance with the information obtained from the RFID tag by the RFID interrogator; and (d) an output unit that is configured to output a signal for the television in accordance with the decrypted information from the decryption unit.

These and other objects, aspects, advantages and features of the present invention will become more apparent from the following detailed description of the presently preferred embodiments taken in conjunction with the accompanying drawings.

### BRIEF DESCRIPTION OF THE DRAWINGS

FIG. 1 is a schematic diagram showing an embodiment of the present invention, including a memory, RFID tag, memory reader, and RFID reader;

FIG. 2 is a schematic diagram showing an RFID tag for use in the present invention;

FIG. 3 is a schematic diagram showing an RFID chip for use in the present invention;

FIG. 4 is a schematic diagram showing an optical medium with an RFID tag for use in the present invention, along with an optical disc drive with an RFID reader for use in the present invention;

FIG. 5 is a schematic diagram showing a flash memory with an RFID tag for use in the present invention;

FIG. 6 is a schematic diagram showing a hard drive with an RFID tag for use in the present invention;

FIG. 7 is a schematic view showing an embodiment of the present invention including a memory/RFID reader connected to a computer;

FIG. 8 is a schematic view showing another embodiment of the present invention including a memory/RFID reader with built-in decryption;

FIG. 9 is a schematic view showing yet another embodiment of the present invention including a DVD player including both a memory/RFID reader and a decryption component;

FIG. 10 is a schematic view showing a memory writer for writing to a memory in accordance with the present invention;

FIG. 11 is a schematic view showing a memory and RFID tag for use in the present invention, the memory and RFID tag being separate from one another.

FIG. 12 is a schematic view showing an RFID chip for use in the present invention, where the memory also stores a counter.

### DETAILED DESCRIPTION OF THE PREFERRED EMBODIMENTS

FIG. 1 shows an embodiment of the present invention. In that figure, reference numeral 1 represents a memory or memory medium. Memory 1 could be a memory of the type that stores digital information. Examples of memory 1 include a CD, DVD, or other optical medium, as well as flash memory, Memory Stick, and hard drive.

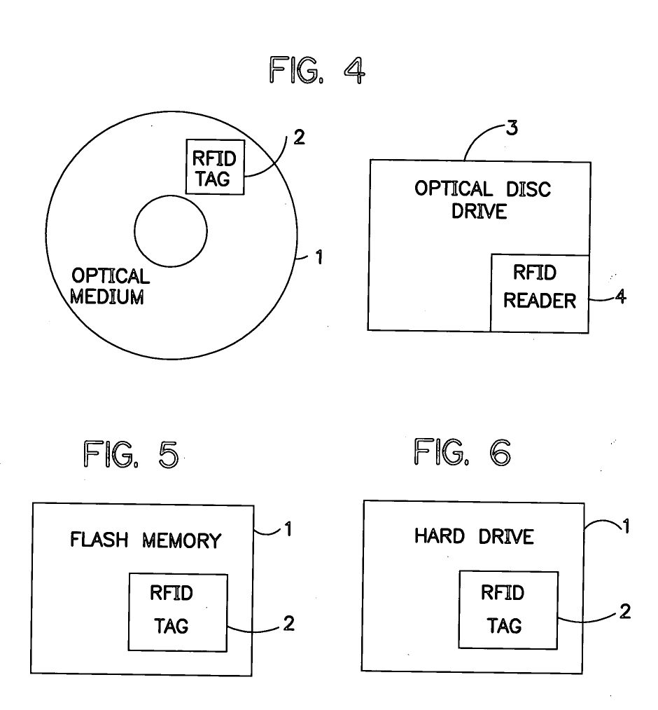

Also in FIG. 1, reference numeral 2 represents an RFID tag. RFID tag 2 preferably comprises an antenna and an RFID chip. RFID tag 2 preferably is attached to memory 1. For example, where memory 1 is a CD or DVD, to attach the RFID tag to the CD or DVD, the antenna could be printed directly on the CD or DVD, and then the RFID chip could be attached to the CD or DVD. A layer could be placed over the antenna and RFID chip so that if someone tried to remove the RFID tag from the CD or DVD, it would be destroyed. FIG. 4 schematically shows a case where RFID tag 2 is attached to memory 1, and memory 1 is an optical medium such as, for example, a CD or DVD. FIG. 5 schematically shows a case where RFID tag 2 is attached to memory 1, and memory 1 is a flash memory. FIG. 6 schematically shows a case where RFID tag 2 is attached to memory 1, and memory 1 is a hard drive.

It is not required, however, that RFID tag 2 be attached to memory 1; as an alternative, RFID tag 2 could be separate from memory 1, as shown in FIG. 11.

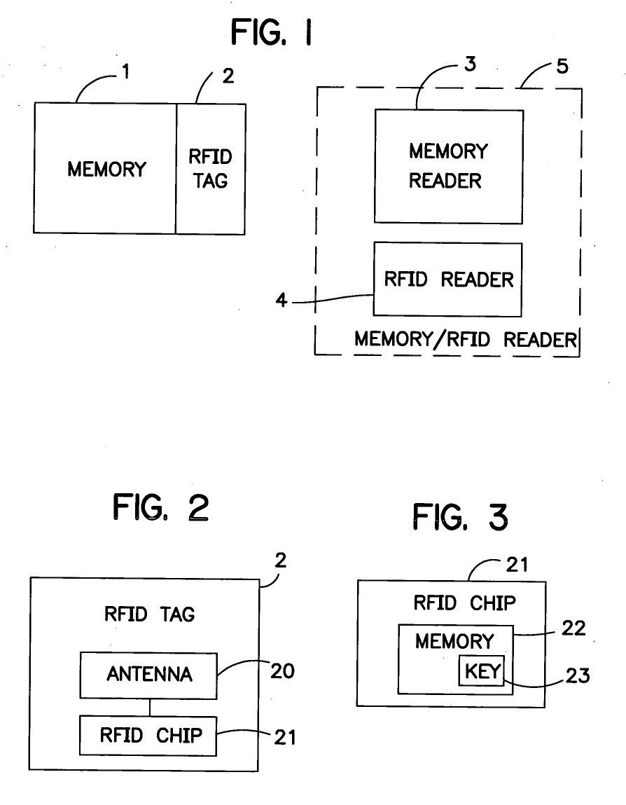

FIG. 2 schematically depicts RFID tag 2 in more detail. In that figure, reference numeral 20 represents an antenna of RFID tag 2, while reference numeral 21 represents an RFID chip of the tag.

FIG. 3 schematically depicts RFID chip 21 in more detail. In that figure, reference numeral 22 represents a memory of RFID chip 21. Information can be stored in this memory, and can include, for example, an encryption or decryption code or key. FIG. 3 depicts the case where memory 22 stores a key 23 for use in decrypting information such as, for example, information stored in memory 1. Such a key may be, for example, 32 bits or 128 bits in length. The information stored in memory 22 could also be used to encrypt information, such as information to be stored on the memory medium.

Returning to FIG. 1, reference numeral 3 represents a memory reader for reading the contents of memory 1. For example, where memory 1 is a flash memory, memory reader 3 could be a flash memory reader. Where memory 1 is instead a CD or DVD, memory reader 3 could be a CD or DVD drive. Of course, memory reader 3 could be the memory reading part of a R/W CD drive or R/W DVD drive also. Reference numeral 4 represents an RFID reader for reading RFID tag 2. RFID reader 4 may be an industry standard RFID reader, e.g., one using a publically-documented protocol for interrogating RFID tags. Alternatively, RFID reader 4 may employ a non-standard, propriety protocol. This latter approach would prevent people with standard RFID readers from obtaining information from RFID tag 2.

Reference numeral 5 represents an optional combination of memory 3 and RFID reader 4 into one device, i.e., a memory/RFID reader. In such a case, memory 3 and RFID reader 4 could be could be attached to one another or integral. For example, where memory reader 3 is an optical disc drive, RFID reader 4 could be attached to or part of that drive. Such is shown in FIG. 4. Alternatively, memory reader 3 and RFID reader 4 could be separate. For example, RFID reader 4 could be disposed adjacent to memory reader 3.

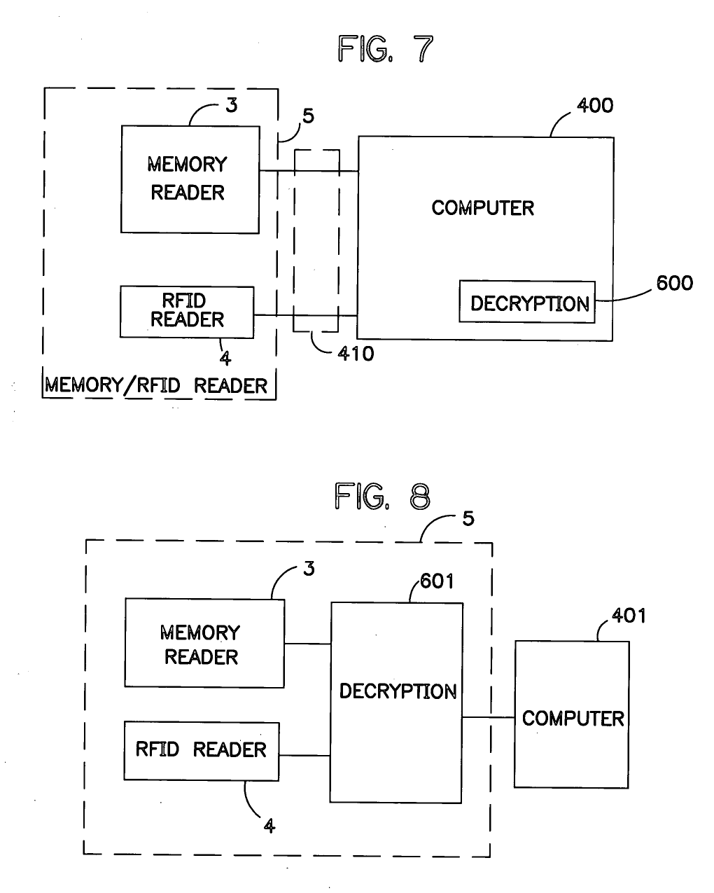

FIG. 7 schematically depicts a deployment of the FIG. 1 embodiment in conjunction with a computer. Reference numeral 400 represents the computer. Examples of such a computer include a personal computer or a personal computing device. Reference numeral 600 represents a decryption unit or decryption software for use with or in computer 400. In operation, RFID reader 4 uses RFID to obtain information stored in memory 22 of RFID tag 2, e.g., key 23. Memory reader 3 performs a reading operation to obtain information stored in memory 1. The information retrieved from memory 22 of RFID tag 2 (e.g., key 23) and the information retrieved from memory 1 are transferred to the computer via an interface 410. Decryption unit 600 then decrypts the information stored in memory 1, as obtained by memory reader 3, in accordance with the information stored in memory 22 of RFID tag 2 (e.g., key 23), as obtained by RFID reader 4.

FIG. 8 depicts an alternate embodiment, which differs from FIG. 7 in that the decryption performed before reaching the computer. Here, reference numeral 601 represents a decryption unit that decrypts information obtained by memory reader 3 from memory 1 in accordance with information obtained by RFID reader 4 from memory 22 of RFID tag 2. Optionally, memory reader 3, RFID reader 4, and decryption unit 601 may be in an integral unit 5 that provides output to computer 401.

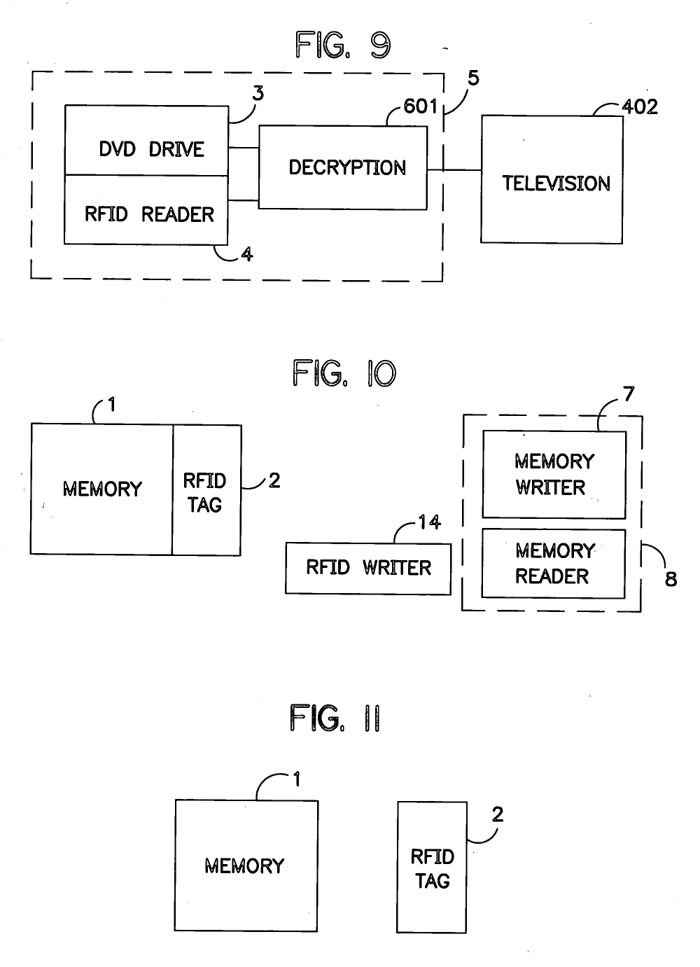

Of course, the invention is not limited to using a computer. FIG. 9 shows an alternate embodiment where reference numeral 5 is an integral unit 5 such as a DVD player, which comprises a DVD drive as memory reader 3, an RFID reader 4 attached to memory reader 3, and the decryption unit 601. The output of the DVD player is supplied to a television 402 for viewing. Memory 1 for use with this embodiment is, for example, a DVD disc. Where that disc contains encrypted information, this embodiment provides a useful as well as easy-to-use copy protection scheme: RFID reader 4 obtains information from RFID tag 2 that is attached or associated with the disc, the DVD drive (memory reader 3) reads the disc, and then decryption unit 601 decrypts the disc in accordance with the information from RFID tag 2. If the proper RFID tag is not present, then the DVD drive will not be able to decrypt, and thus play, the disc, for display on the television.

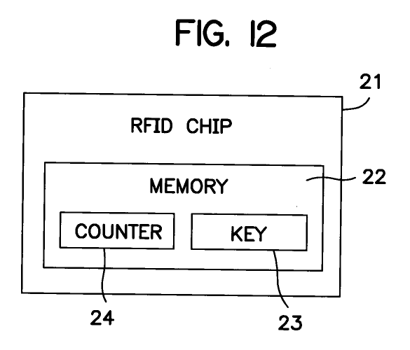

FIG. 10 schematically depicts a system for preparing the memory/RFID tag for use in the present invention. In that figure, reference numeral 7 depicts a memory writer. For example, memory writer 7 could be a device for creating CDs or DVDs, or optionally it could be part of a memory R/W device such as a R/W optical drive (e.g., CD-R/W or DVD-R/W). Reference numeral 8 schematically represents this optional memory R/W device, which includes a memory reader in addition to the memory writer 7. Memory writer 7 writes information for storage by memory 1. Preferably, the information is encrypted, and RFID tag 2 contains information (e.g., a key) used for decrypting the encrypted information, as discussed above. RFID writer 14 writes information to the memory of RFID tag 2, such as the key discussed above.

Other refinements of the invention are possible. For example, since the RFID tag can be written to, one could have an indexing system which would permit a specified number of accesses to a memory medium such as an optical disc or memory device, after which the encryption information stored on the RFID tag would be erased, essentially disabling the disc or memory device. For example, a DVD could be played 10 times, each time indexing a counter stored in the memory of the RFID chip. After 10 plays, the encryption code in the RFID chip would be erased, disabling the DVD. Alternatively, the encryption code need not be erased, but access could be denied to it, or it could be disabled. In reality, only a portion of the encryption code need be erased, or scrambled. FIG. 12 schematically depicts the aforementioned RFID chip, where the memory 22 also contains a counter 24 that is offset by one each time the DVD is played. After the predetermined number of plays, RFID writer 14 or the like may be used to, for example, erase the key from the memory of the RFID chip.

### INDUSTRIAL APPLICABILITY

The present invention provides a memory with an RFID tag, the RFID tag containing information that is used in decryption of the memory, and thus has use as a copy protection scheme.

### CONCLUSION

Except as otherwise disclosed herein, the various components shown in outline or in block form in the figures are individually well known and their internal construction and operation are not critical either to the making or using of this invention or to a description of the best mode of the invention.

Although specific embodiments of the present invention have been described above in detail, it will be understood that this description is merely for purposes of illustration. Various modifications of and equivalent structures corresponding to the disclosed aspects of the preferred embodiments in addition to those described above may be made by those skilled in the art without departing from the spirit of the present invention which is defined in the following claims, the scope of which is to be accorded the broadest interpretation so as to encompass such modifications and equivalent structures.

What is claimed is:

1. A system comprising:
a memory;
an RFID tag;
a memory reading unit that is configured to read information that is stored by said memory;
an RFID reading unit that is configured to read information that is stored by said RFID tag; and
a decryption unit that is configured to decrypt the information read from said memory by said memory reading unit in accordance with the information read from said RFID tag by said RFID reading unit.

2. A system according to claim 1, wherein said RFID tag is attached to said memory.

3. A system according to claim 1, wherein said memory is selected from the group consisting of CD, DVD, flash memory, Memory Stick, optical disc, and hard drive.

4. A system according to claim 1, wherein said memory reading unit optically reads the information that is stored by said memory.

5. A system according to claim 1, wherein said memory is an optical memory medium, and
wherein said memory reading unit is part of an optical disc drive.

6. A system according to claim 5, wherein said RFID reading unit is part of the optical disc drive.

7. A system according to claim 5, wherein said RFID reading unit is attached to the optical disc drive.

8. A system according to claim 1, further comprising a memory writing unit for writing information to said memory for storage.

9. An apparatus comprising:
a memory reading unit that is configured to read information that is stored by a memory;
an RFID reading unit that is configured to read information that is stored by an RFID tag; and
a decryption unit that is configured to decrypt the information read from the memory by said memory reading unit in accordance with the information read from the RFID tag by said RFID reading unit.

10. An apparatus comprising:
memory reading means for reading information that is stored by a memory;
RFID reading means for reading information that is stored by an RFID tag; and
decryption means for decrypting the information read from the memory by said memory reading means in accordance with the information read from the RFID tag by said RFID reading means.

11. A method comprising:
retrieving information from a memory;
retrieving information from an RFID tag; and
decrypting the information retrieved from the memory in accordance with the information retrieved from the RFID tag.

12. A method according to claim 11, wherein the information retrieved from the RFID tag comprises a key used for said decrypting.

13. A system comprising:
a memory;
an RFID tag attached to said memory;
an encryption unit that is configured to encrypt information so that the encrypted information can later be decrypted, the decryption being performed in accordance with information obtained from said RFID tag; and
a writing unit that is configured to write information to said memory for storage,
wherein the encrypted information from said encryption unit is written by said writing unit to said memory for storage.

14. A system according to claim 13, wherein said memory is selected from the group consisting of CD, DVD, flash memory, Memory Stick, optical disc, and hard drive.

15. A system according to claim 13, wherein said writing unit is part of an optical disc drive, and said writing unit optically writes information to said memory for storage.

16. A system according to claim 13, wherein said memory is an optical disc.

17. A system according to claim 16, wherein said RFID tag comprises an antenna that is printed on said optical disc.

18. An apparatus comprising:
encryption means for encrypting information so that the encrypted information can be decrypted, the decryption being performed in accordance with information retrieved from an RFID tag attached to a memory; and
writing means for writing the encrypted information to the memory for storage.

19. A method comprising:
writing first information to an RFID tag for storage, the RFID tag being associated with a memory;
encrypting second information so that the encrypted second information can later be decrypted, the decryption being performed in accordance with the first information; and
writing the encrypted second information to the memory for storage.

20. An apparatus for use with a television, said apparatus comprising:
an optical disc drive that is configured to perform one of (a) reading from an optical disc and (b) reading from and writing to an optical disc;
an RFID interrogator that is configured to obtain information from an RFID tag associated with the optical disc;
a decryption unit that is configured to decrypt information read from the optical disc by said optical disc drive in accordance with the information obtained from the RFID tag by said RFID interrogator; and
an output unit that is configured to output a signal for the television in accordance with the decrypted information from said decryption unit.

21. An apparatus according to claim 20, said apparatus being a DVD player.

22. An apparatus according to claim 20, wherein said RFID tag is attached to the optical disc.
